(19) United States
(12) Patent Application Publication
(10) Pub. No.: US 2021/0032128 A1
(43) Pub. Date: Feb. 4, 2021

(54) CYANOBACTERIUM MITIGATION DEVICE AND METHOD OF USING THE SAME

(71) Applicants: Jason A. Dean, Kirkville, NY (US); Joseph B. Milstein, Brookline, MA (US)

(72) Inventors: Jason A. Dean, Kirkville, NY (US); Joseph B. Milstein, Brookline, MA (US)

(21) Appl. No.: 16/942,773

(22) Filed: Jul. 30, 2020

Related U.S. Application Data
(60) Provisional application No. 62/880,555, filed on Jul. 30, 2019.

(51) Int. Cl. C02F 1/36; C02F 1/32

(52) U.S. Cl. CPC C02F 1/36; C02F 2303/04; C02F 1/32

(57) ABSTRACT

The invention relates to the mitigation of harmful water-borne bacteria such as cyanobacteria. Multiple apparatus are described. One apparatus can apply at least one of UVC irradiation, microbubbles and ultrasonic sound to mitigate the harmful water-borne bacteria. Methods of mitigation of the harmful bacteria are described that do not involve the application of chemicals.

### CROSS-REFERENCE TO RELATED APPLICATIONS

This application claims priority to and the benefit of co-pending U.S. provisional patent application Ser. No. 62/880,555, filed Jul. 30, 2019, which applications is incorporated herein by reference in its entirety.

### FIELD OF THE INVENTION

The invention relates to the mitigation of cyanobacterium in general and particularly to systems and methods for mitigating cyanobacterium without the application of chemical agents.

### BACKGROUND OF THE INVENTION

The Centers for Disease Control (CDC) has recently launched a Harmful Algal Bloom (HAB) website in order to track widespread cyanobacteria bloom outbreaks nationally. A recent report from 2016 indicated harmful algal blooms outbreaks in 17 states in the month of September alone.

According to the CDC, algal blooms are quickly becoming a public health issue, resulting in symptoms ranging from mild to severe. Typical symptoms of HAB toxins include skin irritation, stomach and intestinal cramping, lung and central nervous system impairments. HAB toxins are harmful to both humans and animals.

Cyanobacteria blooms form when water is both warm and nutrient rich, for example from fertilizer runoff. The blooms typically appear in mid to late summer as the bodies of water begin to warm. Nutrients such as phosphorus and nitrogen help to feed this bacterium, which typically multiply during the night and rise to spread across a water's surface.

The appearance of cyanobacterium blooms often resembles floating green paint, which often give off a strong odor when they die. The blooms often block out light that organisms require to thrive in the water, as well as to deplete the water source of valuable oxygen. Cyanobacterium often produce cyanotoxins, which are dangerous natural toxins that cause a variety of harmful effects in both humans and animals.

Excessive algal growth as a result of an increase in growth factors needed to support photosynthesis, also known as eutrophication, causes an estimated at $2.2 billion dollars in damage annually in the U.S. alone. Often these damages are the result of blooms of blue green algae, also known as cyanobacteria, which contaminate drinking water supplies and recreational areas.

A typical consequence of vast blue green algae blooms is the foul odor that often emanates from decomposing algae as they die off. These dense blooms often block out the sunlight that is needed to help support organisms that typical thrive in the water, but become starved from sunlight as a result of the dense coverage that often lay on the surface of the water. As the algae die off, often-inorganic carbon is depleted that results in an increase in water pH levels. An additional consequence of decomposition is the depletion of dissolved oxygen, a factor that has been known to create hypoxic or anoxic conditions that are unable to support life.

More recently, hypoxic events have been found along marine coastal environments, such as those found along the Mississippi River, Gulf of Mexico, Susquehanna River, and Chesapeake Bay, which endanger lucrative commercial and recreational fisheries. These hypoxic events often impact large areas, for example approximately 245,000 square kilometers in these same areas. Of course, these events are not only limited to coastal marine areas, but they have also been found in many freshwater lakes as well, such as Lake Erie.

Recently an exceptionally hot weather pattern has pushed water temperatures in most of the Great Lakes to the highest levels on record so early in the summer. Over lakes Erie and Ontario, the water is the warmest it has been since records began being kept, and could warm more in the coming weeks. The abnormally warm waters, consistent with climate-change trends in recent decades, could compromise water quality and harm marine life in some areas. Surface water temperatures averaged over all of the Great Lakes, except the deep and choppy Lake Superior, have risen well into the 70s while Lake Erie has flirted with 80 degrees.

Blue-green algae or cyanobacteria over western waters of Lake Erie in early July 2020. The foul-smelling algal blooms can harm fish and make people who are exposed to the water sick. In 2014, cyanobacteria from Lake Erie entered the water supply in Toledo, and residents were ordered not to drink or touch the water. The jump-start to the algal bloom due to the warm water temperatures means it will be around for several weeks longer than normal. The earliest observed algae blooms in the Great Lakes occurred in June in 2018.

Specific conditions which support the growth of algae blooms include water which embodies thermal stratification. This occurs when the upper layer of water is warmer than the lower layers, which often occurs when the two thermal layers stop mixing. This reduced thermal mixing often occurs when the waters are calm.

In the last decade, Lake Erie has experienced repeated harmful cyanobacteria blooms (cHABs) and cyanotoxins that have likely resulted in probable cases of human illness. A prevalent toxigenic cyanobacterium has been the Microcystis genus, which are known to produce microcystins. Furthermore, other cyanotoxins have also been identified, such as anatoxin-a, that implicate the presence of other toxigenic cyanobacteria like Anabaena (Dolichospermum) and Lyngbya.

The cells of cyanobacterium (Anabaena flos-aquae), are capable of producing neurotoxins, which have the capacity to interfere with the central nervous system. These neurotoxins can disrupt the communication between neurons and muscle cells, which can lead to death by causing paralysis of respiratory muscles.

Not all cyanobacteria produce blue-green algae, but some result in “red tides” or red water blooms. The same methods of the invention can be deployed against these bacteria as well.

Cyanotoxins are classified based on two criteria: (1) by their action mechanism in land vertebrates, which are broken into 3 sub-groups; hepatoxins, neurotoxins, and dermatotoxins; and (2) their overall chemical structure, which is also broken into 3 sub-groups; cyclic peptides, alkaloids, or lipopolysaccharides (LPS).

Hepatoxins can cause the rupture of structures within the liver by means of hypovolemic shock, resulting in excessive accumulation of blood within the liver. Hepatoxins can also interfere with the control of cellular structure and function of the liver by inhibiting protein phosphatases type 1 or 2 (PP1 or PP2A).

The most toxic compounds often produced by cyanobacteria are known as neurotoxins. These toxins can cause paralysis of the respiratory muscles by interfering with the neuromuscular system, which has been shown to cause death in laboratory rats in just minutes. One such neurotoxin are the saxitoxin type, also referred to as PSPs (paralytic shellfish poisoning), mainly due to how this toxin was first identified from humans consuming contaminated bivalve mollusks. These same toxins were also found to be the result of what has become known as the “red tide” phenomenon.

Cyanotoxins that are classified as dermatotoxins, aplysiatoxins and lyngbiatoxins have each been identified in marine cyanobacteria, which have been known to cause severe dermatitis for those who bath in coastal waters infected with the cyanobacteria.

In the prior art, chemical methods for controlling cyanobacteria growth have included the use of hydrogen-peroxide, which causes an oxidation process by which the hydrogen peroxide (H₂O₂) breaks down into water (H₂O) and pure oxygen (O₂), resulting in the death of exposed bacteria. The limitation here is that beneficial bacteria will also die as a result of its use, so great care is needed when employing this chemical agent. Another chemical method for controlling the spread of cyanobacteria is the use of antibiotics. Antibiotics such as Maracyn and Erythromycin have been found to be effective in killing cyanobacteria. Once more however the use of antibiotics to treat cyanobacteria will also interfere with the processes of beneficial bacteria as well.

Flesh eating bacteria have recently been identified as a problem in water, such as lakes, rivers, and the sea.

There is a need for systems and methods to mitigate cyanobacteria and other harmful water borne bacteria, without the expense and dangers associated with employing chemical methods.

### SUMMARY OF THE INVENTION

According to one aspect, the invention features an apparatus configured to collect and mitigate a harmful water-borne bacteria, comprising: a water-going apparatus having a propulsion system, the water-going apparatus configured to collect water containing the harmful water-borne bacteria as a consequence of motion of the water-going apparatus relative to a body of water; the water-going apparatus having a mechanical mechanism configured to collect and to localize water containing the harmful water-borne bacteria; the water-going apparatus having at least one of an irradiation source, a source of microbubbles, and an ultrasonic transducer configured to apply, respectively, an illumination, a microbubble and ultrasonic sound to the localized water containing the harmful water-borne bacteria; and the water-going apparatus having a controller configured to communicate with the at least one of the irradiation source, the source of microbubbles, and the ultrasonic transducer to control the respective operation of each.

In one embodiment, the harmful water-borne bacteria is cyanobacteria.

In another embodiment, the cyanobacterium is blue green algae.

In yet another embodiment, the irradiation source comprises a UV-A, UV-B or UV-C irradiation source.

In still another embodiment, the irradiation source is configured to irradiate the harmful water-borne bacteria with electromagnetic radiation so as to render the harmful water-borne bacteria harmless.

In a further embodiment, the irradiation source is configured to irradiate the cyanobacterium so as to kill the harmful water-borne bacteria.

In yet a further embodiment, the irradiation source is configured to irradiate the harmful water-borne bacteria so as to cause adverse effects in genome integrity of the harmful water-borne bacteria.

In an additional embodiment, the irradiation source is configured to produce UV-induced mutations in the harmful water-borne bacteria.

In one more embodiment, the mechanical mechanism comprises at least one of a paddle, a fixed filter, or electromechanical pump.

According to another aspect, the invention relates to an apparatus configured to mitigate a harmful cyanobacterium, comprising: a mechanical mechanism configured to collect and to localize water containing the harmful cyanobacterium; at least one of an irradiation source, a source of microbubbles, and an ultrasonic transducer configured to apply, respectively, an illumination, a microbubble and ultrasonic sound to the localized water containing the harmful cyanobacterium; and a controller configured to communicate with the at least one of the irradiation source, the source of microbubbles, and the ultrasonic transducer to control the respective operation of each.

According to another aspect, the invention relates to a method of collecting and mitigating a harmful water-borne bacteria, comprising the steps of: providing an apparatus comprising: a water-going apparatus having a propulsion system, the water-going apparatus configured to collect water containing the harmful water-borne bacteria as a consequence of motion of the water-going apparatus relative to a body of water; the water-going apparatus having a mechanical mechanism configured to collect and to localize water containing the harmful water-borne bacteria; the water-going apparatus having at least one of an irradiation source, a source of microbubbles, and an ultrasonic transducer configured to apply, respectively, an illumination, a microbubble and ultrasonic sound to the localized water containing the harmful water-borne bacteria; and the water-going apparatus having a controller configured to communicate with the at least one of the irradiation source, the source of microbubbles, and the ultrasonic transducer to control the respective operation of each; operating the water-going apparatus to collect a harmful water-borne bacteria in a specimen of water; using the controller to operate at least one of the at least one of an irradiation source, a source of microbubbles, and an ultrasonic transducer to apply, respectively, an illumination, a microbubble and ultrasonic sound to the localized water containing the harmful water-borne bacteria; and thereby mitigating the harmful water-borne bacteria.

In one embodiment, the irradiation source comprises a UV-A, UV-B or UV-C irradiation source.

In another embodiment, the harmful water-borne bacteria is a cyanobacteria.

In yet another embodiment, the cyanobacterium is blue green algae.

According to one aspect, the invention features a device configured to collect and irradiate harmful cyanobacteria comprising: a mechanical filtering action; at least one mechanical mechanism configured to collect and to localize cyanobacteria; and an irradiation source.

In one embodiment, the irradiation source comprises of UV-A, UVB, UV-C, or germicidal irradiation source.

In another embodiment, the irradiation source comprises a UV or germicidal source configured to render the cyanobacterium unable to reproduce.

In yet another embodiment, the irradiation source is configured to kill the cyanobacterium.

In a further embodiment, the irradiation source is configured to render other harmful water borne bacteria, such as flesh eating bacteria, harmless.

In a further embodiment, the irradiation source is configured to render harmful water borne viruses harmless.

In still another embodiment, the irradiation source is configured to emit non-ionizing radiation.

In a further embodiment, the non-ionizing radiation source does not leave a residue and or other chemical trace elements.

In yet a further embodiment, the cyanobacterium is one of Cyanothece, Microcystis, Phormidium, and Anabaena.

In an additional embodiment, the irradiation source is configured to disrupt the cellular processes of the cyanobacterium required to sustain life.

In one more embodiment, the irradiation source is configured to disrupt the proper functioning of DNA and RNA of cyanobacterium.

In still a further embodiment, the irradiation source is configured to emit at least one of UV-A, UV-B, UV-C illumination.

In another embodiment, the irradiation source is configured to emit one or more wavelengths contained within the UV spectrum.

According to another aspect, the invention relates to a mechanical apparatus configured to navigate water to collect harmful cyanobacterium, comprising; a UV filtering mechanism configured to receive contaminated water, an irradiation chamber wherein said water is localized, said chamber is configured to permit water flow through or past irradiation sources, and configured to permit said water to exit through another UV filtering mechanism.

In one embodiment, the mechanical apparatus is configured to cause the water to move or flow through the apparatus by movement of the device as it navigates the water.

In another embodiment, the mechanical apparatus comprises a mechanical pump configured to cause the water to move or flow through the apparatus.

In yet another embodiment, the device comprises a macerator configured to pass received water therethrough.

In still another embodiment, the macerator is configured to reduce the size of cyanobacterium or algae.

In a further embodiment, the apparatus comprises a rotating paddle system configured to assist water movement.

In yet a further embodiment, said paddle system is configured to produce a mass reduction of passing algae.

In an additional embodiment, said paddle system is configured to prevent UV light from irradiating beyond the opening of the device.

In one more embodiment, the UV filtering system is comprised of a series of round cylinders positioned in an off-setting pattern designed to prevent UV light from exiting at each opening of the device.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 depicts a cross section of one configuration of a cyanobacterium mitigating apparatus, which apparatus is capable of traversing water, supported by floatation assist pontoons.

FIG. 2 depicts one configuration of the layout for the irradiation sources in which the irradiation sources are depicted in a horizontal position.

FIG. 3 depicts a cross section view of the irradiation sources configured in a horizontal position.

FIG. 4 schematic diagram in cross sectional view that depicts one embodiment for providing propulsion to the apparatus comprising a propulsion device located in the stern of the apparatus.

FIG. 5 is a schematic diagram in plan view that depicts a second location of a propulsion systems.

FIG. 6A is a schematic diagram in cross sectional view that depicts a cross section of external supports to the irradiation chamber.

FIG. 6B is a is a schematic diagram in plan view of the irradiation chamber.

FIG. 7 is a schematic diagram that depicts the propulsion systems configured to be clamped to the device, particularly by being thru-bolted to external supports.

FIG. 8 depicts the electromagnetic spectrum comprising the UV spectrum along with a curve illustrating the absorption coefficient of illumination in water.

FIG. 9 schematically illustrates the impact of varying UV wavelengths (UV-A, UV-B, and UV-C) on the biological processes of cells.

FIG. 10 is an image of a benchtop prototype apparatus useful for mitigating cyanobacteria.

### DETAILED DESCRIPTION

The invention relates to the mitigation of harmful water-borne bacteria such as cyanobacteria.

In general terms, the invention can be understood by recognizing that an apparatus is designed to traverse a body of water by means of a propulsion system. As the apparatus traverses the water, it collects and localizes water into an irradiation chamber. As the water passes through the irradiation chamber, it is exposed to at least one irradiation source. In some embodiments, the water is subjected to the addition of microbubbles. In some embodiments, the water is subjected to ultrasonic sound. The irradiation sources are localized so as to ensure optimal exposure of UV wavelengths to the collected water. A result from the irradiation sources is a disruption in the cellular processes of the microorganisms contained within the water. As the water exits the irradiation chamber, all specimens are returned to the same body of water. The system is not designed to extract or hold any material, other than samples for testing, nor does it emit any harmful chemicals into the water. The organisms collected by the apparatus are returned to the water with one very important feature; that the organisms (cyanobacterium) have now been exposed to a sufficient irradiation level so as to disrupt their cellular processes. The result is cell death. In one embodiment, the apparatus is designed to traverse a body of water, rather than bringing the water to the apparatus. This apparatus can be brought into an area as a preventative method, or to reduce the longevity of an already existing blue-green algae outbreak.

The invention provides systems and methods that render such cyanobacteria unable to replicate, by means of interfering with their DNA and RNA processes, without the expense and dangers associated with employing chemical methods.

In one embodiment, the present invention comprises an electromechanical device, designed to collect cyanobacterium from a water source, and to direct their movement in and about an irradiation source, whereby said cyanobacterium are subjected to concentrated irradiation, such as from a plurality of a UV (UV-A, UV-B, UV-C) light source. Said collection system is designed to extract cyanobacterium from source water, and to neutralize the harmful bacteria, such as to interfere with the DNA and RNA processes involved in cellular functioning, thereby rendering the bacterium unable to sustain life and or the ability to replicate; all of which are subject to neutralization through the repeated exposure to an irradiation type light source.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

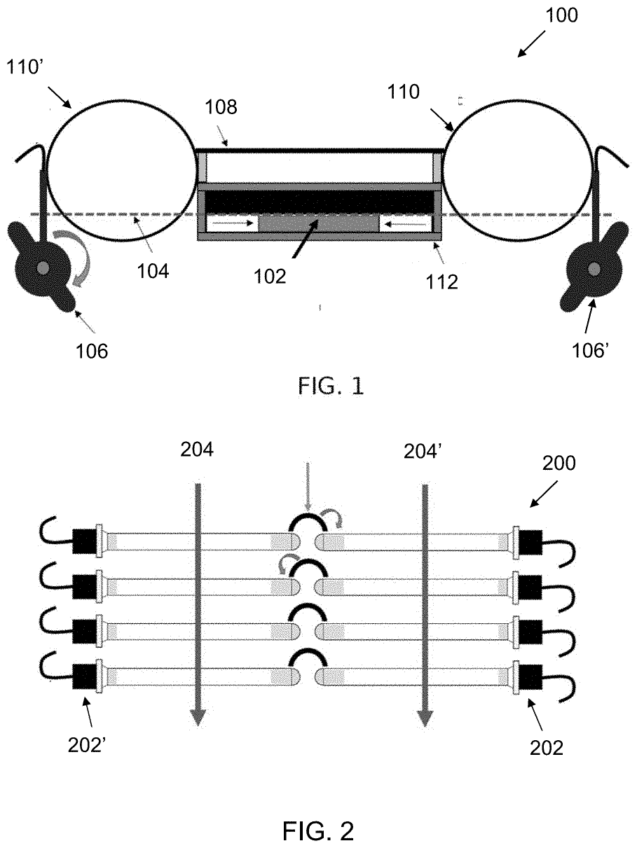

FIG. 1 is a cross sectional diagram 100 in which are shown an irradiation chamber 102, a water level represented by dotted line 104, motors 106, 106′, a deck 108, pontoons 110, 110′ and a funnel-like water entry denoted by arrows 112.

FIG. 1 depicts the apparatus with an irradiation chamber, wherein cyanobacterium are collected and localized. The localization allows cyanobacterium to receive a lethal dose of UV light.

The apparatus of FIG. 1 is configured to traverse at or near the surface of the water where thermal stratification is likely to occur. The stratification causes the collection of cyanobacterium at or near a water's surface.

The apparatus of FIG. 1 is further comprised of propulsion devices to aid in the traversing through water.

The propulsion devices of FIG. 1 are configured as either electric or fuel assisted propulsion systems. In various embodiments, power may be supplied by batteries, by renewable energy sources, by fuel powered engines or by fuel powered electrical generators.

The apparatus of FIG. 1 is configured to include a deck or dry area configured to house control and navigation electronics.

FIG. 2 is a plan view of the layout of an irradiation chamber 200 in which are located one or more irradiation sources 202, 202′ and in which diagram is shown the direction of a water flow illustrated by arrows 204, 204′.

FIG. 2 depicts one configuration of the layout for the irradiation sources in which the irradiation sources are depicted in a horizontal position.

The irradiation sources of FIG. 2 can also be configured in a vertical position.

The irradiation sources of FIG. 2 are configured to receive directed water flow by means of employing baffles. The baffles are configured to redirect water flow towards the irradiation sources to maximize irradiation exposure.

The irradiation sources of FIG. 2 are depicted in two rows of 16. The irradiation sources may include more or fewer irradiation sources. In some instances the terms “irradiation” and “illumination” are used interchangeably, but are intended to refer to light in one or more of the ultraviolet ranges of UVA, UVB, and UVC, and/or to cavities in which such ultraviolet light may be applied to samples of interest.

The irradiation sources of FIG. 2 are designed to permit water to flow in and around the irradiation sources. The water is localized around the irradiation sources to ensure optimum exposure of UV sources.

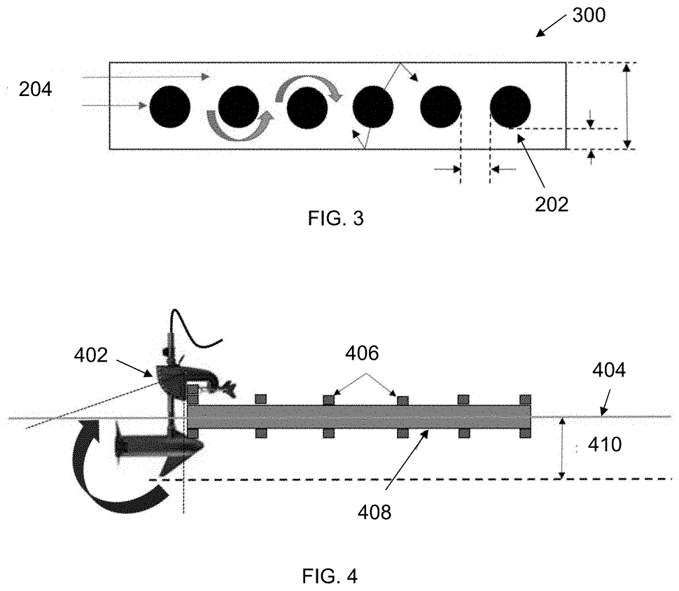

FIG. 3 is a cross section view of the irradiation chamber 200, in in which are located one or more irradiation sources 202, 202′ and in which diagram is shown the direction of a water flow illustrated by arrows 204, 204′.

FIG. 3 depicts a cross section view of the irradiation sources configured in a horizontal position.

The irradiation sources of FIG. 3 are configured to permit water flow in and around the irradiation sources. The flow is localized to ensure optimum exposure of UV sources.

As illustrated in FIG. 3 the localization of water in the irradiation chamber is used to control the intensity of irradiation that is applied to specimens of interest. The inverse square law states that as irradiation propagates to a distance twice a distance from its origin will spread out to 4 times the coverage area, resulting in ¼^{th} the intensity.

FIG. 4 is a schematic diagram 400 in cross sectional view illustrating the mounting of a motor 402 in which is illustrated a water level 404, a cage or support 406 for an illumination chamber 408, and a distance 410 representing a clearance distance to allow the motor 402 to operate without encountering obstacles.

FIG. 4 depicts one configuration for providing propulsion to the apparatus comprising a propulsion device located in the stern of the apparatus.

The of apparatus of FIG. 4 further comprises of external supports for the irradiation chamber. The supports of FIG. 4 are designed to prevent flexing of the irradiation chamber from pressures acting on its external surfaces. The pressures acting on its surfaces include buoyancy and momentum factors.

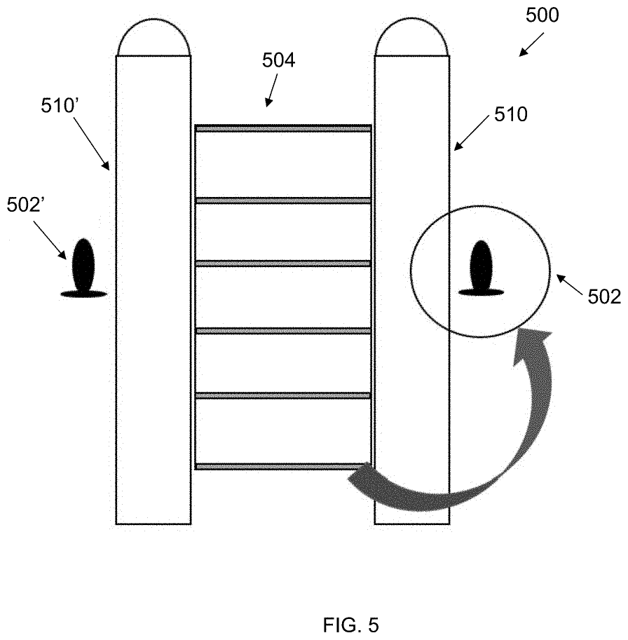

FIG. 5 is a schematic diagram 500 in plan view in which are illustrated pontoons 510, 510′ to which are attached motors 502, 502′ and which pontoons support an illumination chamber 504.

FIG. 5 depicts a second location of propulsion systems. The revision serves to aid in navigation, as well as a reduction in applied forces necessary to steer the device through the water. Furthermore, the revision of FIG. 5 helps to balance the weight of the propulsion systems on the device.

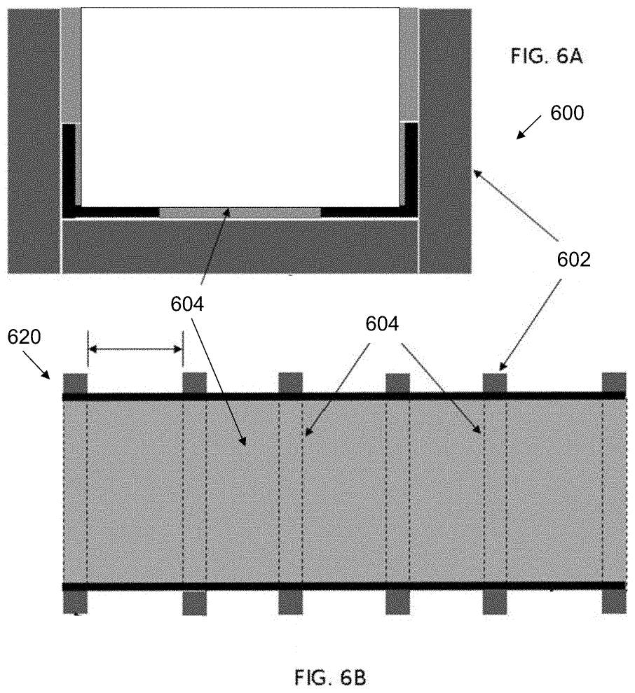

FIG. 6A is a schematic diagram 600 in cross sectional view illustrating a support structure 602 that is configured to contain an illumination chamber 604.

FIG. 6A depicts a cross section of external supports to the irradiation chamber. The supports are comprised of angular and tubular supports, in both horizontal and vertical configurations. The supports encapsulate the irradiation chamber.

The external supports of FIG. 6A are further comprised of foam. The foam of FIG. 6A is configured to provide a separation between the irradiation chamber and the external supports. The foam provides both a flexible lining to absorb vibration, as well as to reduce friction between the irradiation chamber and the external supports.

The external supports of FIG. 6A are configured as a cage. The cage is configured to encapsulate, or to provide support for the irradiation chamber.

The external supports of FIG. 6A are configured to be removable. The external top supports of FIG. 6A are configured to be removable to provide access to the irradiation chamber.

FIG. 6B is a is a schematic diagram 620 in plan view illustrating a plurality of support structures 602 that are configured to contain an illumination chamber 604.

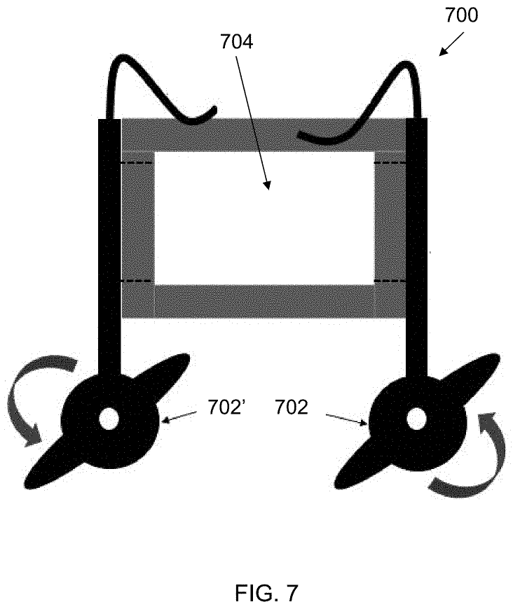

FIG. 7 is a schematic diagram 700 in which are illustrated motors 702 attached to an illumination chamber 704. By driving each of the motors separately, the apparatus can be steered in the water.

FIG. 7 depicts the propulsion systems configured to be clamped to the device, particularly by being thru-bolted to external supports of FIG. 6A.

The propulsion systems of FIG. 7 are configured to be controlled via electrical communication cables. The communication cables are in electrical communication with a control module.

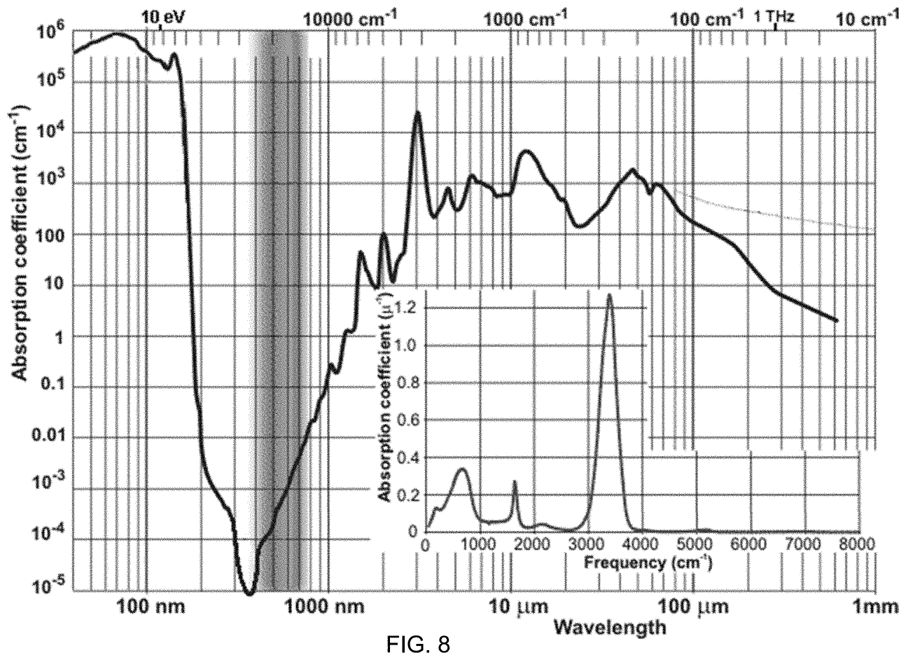

FIG. 8 depicts the electromagnetic spectrum comprising the UV spectrum along with a curve illustrating the absorption coefficient of illumination in water. The wavelength of UV radiation (UVR) lies in the range of 100-400 nm and is further subdivided into UVA (315-400 nm), UVB (280-315 nm), and UVC (100-280 nm). The UV component of terrestrial radiation from the midday sun comprises about 95% UVA and 5% UVB; UVC and most of UVB are removed from extraterrestrial radiation by stratospheric ozone.

The optimal germicidal UV wavelength of UVC is situated at approximately 264 nm.

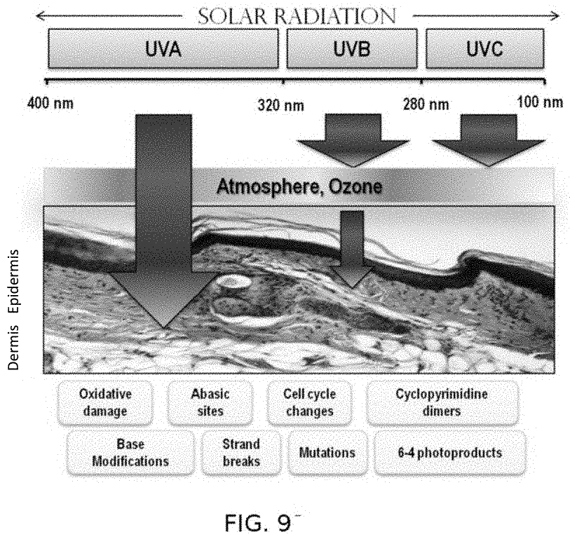

FIG. 9 schematically illustrates the impact of varying UV wavelengths (UV-A, UV-B, and UV-C) on the biological processes of cells.

FIG. 9 describes how exposure to UV-A light can affect the health of cells by generating oxidative damage and strand breaks in DNA.

FIG. 9 describes how exposure to UV-B light can affect the health of cells by generating cell cycle changes and mutations in cellular processes.

FIG. 9 describes how exposure to UV-C light can affect the health of cells by generating cyclo pyrimidine dimers (lesions) in cells.

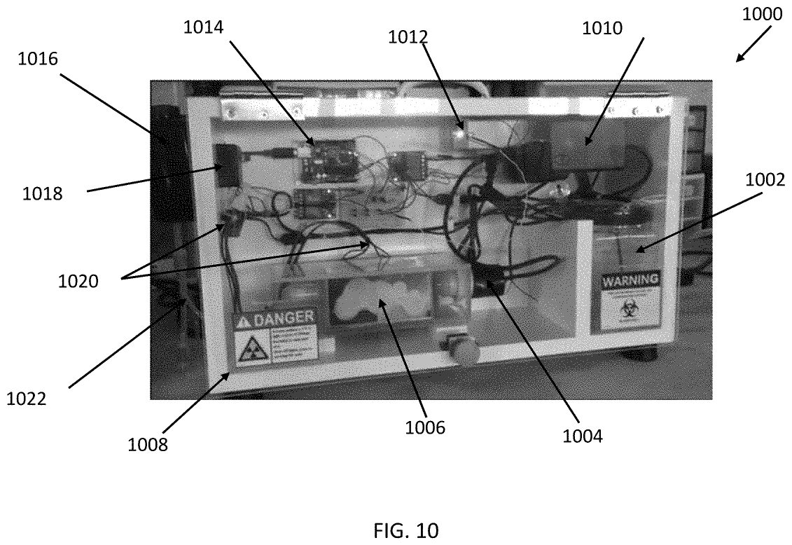

FIG. 10 is an image of a benchtop prototype apparatus 1000 useful for mitigating cyanobacteria. In FIG. 10, there are illustrated a containment/storage vessel 1002, a UVC lamp 1004, an optical chamber 1006 built from acrylic exterior blocks which prevent 98% of UVC from escaping, an acrylic safety window 1008 that permits visual observation during the operation of the apparatus, a UVC lamp ballast 1010, multi-colored LED safety indicators 1012 (red, yellow, green), an Arduino UNO microcontroller unit 1014, a 4-watt variable air supply 1016, an ultrasonic generator 28 Khz @ 0.75-watt 1018, direct electrical communication between the ultrasonic generator and transducers 1020 and an air line with directional valve 1022.

The Arduino Uno is an open-source microcontroller board based on the Microchip ATmega328P microcontroller and developed by Arduino.cc. The board is equipped with sets of digital and analog input/output (I/O) pins that may be interfaced to various expansion boards (shields) and other circuits. The board has 14 digital I/O pins (six capable of PWM output), 6 analog I/O pins, and is programmable with the Arduino IDE (Integrated Development Environment), via a type B USB cable. It can be powered by the USB cable or by an external 9-volt battery, though it accepts voltages between 7 and 20 volts. It is similar to the Arduino Nano and Leonardo. The hardware reference design is distributed under a Creative Commons Attribution Share-Alike 2.5 license and is available on the Arduino website. Layout and production files for some versions of the hardware are also available. Arduino products may be purchased from various venders such as Newark, 300 S. Riverside Plaza, Suite 2200, Chicago, Il 60606.

Operation of the apparatus illustrated in FIG. 10 is now described, and results obtained are illustrated in Table I below. The cyanobacteria are loaded into the optical chamber. The chamber consists of optical mirrors (97% reflectivity) and has a Rexim 6-watt UVC lamp (Quartz sleeved 254 nm UV output @ 1 cm=5000 μw/cm²) configured horizontally through the chamber. The sequence is controlled via microprocessor control, which is activated only when the indicator LED displays green. The sequence is initiated via external laptop in electrical communication with the Arduino via a USB. Once initiated, the program activates a combination of UVC, air injection (Zhongle nanobubble generating ceramic air stone Model #ASC-89204), and Kemo ultrasound generator (Model #M048N, operating at 12-15 VDC @<50 mA) via a relay switch. Power is derived from a ballast, which is in electrical communication with line voltage source. Light escaping the chamber is blocked (98%) by its exterior acrylic, which is further enhanced by an additional acrylic window which adds an additional 98% of blockage. Upon completion of the sequence, the LED changes from red to green, indicating that it is safe to remove the sample. This benchtop utilizes UVC, air, and ultrasound sources alone or in combination for mitigation of cyanobacteria. It is believed that each of the UVC illumination, microbubbles of air and ultrasonic energy, alone or in combination, can mitigate the cyanobacteria.

TABLE I
Experimental Results

| | | Sonication | | Net |
|---|---|---|---|---|
| | Microbubble | Intensity/ | Observation | Reduc- |
| UVC dose | addition | frequency | Period | tion |
| 24 watt-seconds | | | 24 hours | −59.2% |
| 36 watt-seconds | | | 24 hours | −78.8% |
| 36 watt-seconds | yes | | 24 hours | −80.4% |
| 48 watt-seconds | yes | 6 watt-seconds/ | 24 hours | −96.5% |
| | | 28 kHz | | |
| 48 watt-seconds | yes | 6 watt-seconds/ | 72 hours | −78% |
| | | 28 kHz | | |

### Methods

There are three embodiments which are incorporated within the irradiation chamber and they include the following.
1. Nanobubbles which act as a harassing agent to transport bacteria towards the UVC light because of a change in their buoyancy.
2. UVC irradiance which kills and or disrupts the cellular functioning of cyanobacteria by corrupting their DNA
3. Ultrasonic transducers operating at above 20 kHz break up internal gas vesicles or other structures within the cyanobacteria.

The irradiance chamber is designed to adjust its elevation in a body of water to optimize the localization of cyanobacteria. In some embodiments, as the cyanobacteria pass through the system, they can be bombarded with a cloud of nanobubbles. These bubbles are designed to attach to the surface of the cell membranes resulting in a change in their buoyancy or to provide a lifting action. This change in buoyancy generates a lifting action that causes an ascent of the cyanobacteria towards the UVC sources. Theoretically it would be possible for the bacteria to flow through the system unharassed in the absence of a harassing agent. In the case of the irradiance chamber the nanobubbles become an agent that prevent the bacteria from flowing through the chamber with a reduced exposure to the UVC sources. As the bacteria ascend they become proximate to the UVC sources. This results in enhanced exposure to the UVC source. For example, by bringing the bacteria closer to the surface of the water, there is less water through which the UVC illumination (or equivalently, UVC radiation) has to pass. As may be seen from the visible and UV spectra of liquid water shown in in FIG. 10, the absorption coefficient of water in the range of 100-200 nm rises steeply, so foreshortening the distance that the UVC has to travel in the water effectively allows a higher total intensity of UVC (for the same source intensity) to reach the bacteria.

In some embodiments, the UVC light is the primary source of disruption of cyanobacteria. In various embodiments, UVC light, nanobubbles and ultrasonic sound provided by ultrasonic transducers may be used individually or in coOmbination to mitigate cyanobacteria.

The ultrasonic transducers can be used alone or as an augmentation system to the UVC lamps. Sound travels quite nicely through water regardless of its turbidity. If there is a significant change in the turbidity of the water, the use of ultrasonic frequencies has been added to enhance the mitigation of cyanobacteria in response to those changes in turbidity. The ultrasonic transducers are designed to emit high frequency sound designed to penetrate the cell membranes of the cyanobacteria. This passthrough action allows the mitigation of the cells by inducing cellular changes because of the use of high frequency vibrations. These ultrasonic vibrations are designed to disrupt the air vesicles within the cyanobacteria which they utilize to manipulate their buoyancy in the water. The ultrasonic vibrations may also disrupt cyanobacteria by interaction with microbubbles on the surface of the cyanobacteria. Under normal operation the cyanobacteria manipulate their buoyancy to position themselves in favorable elevations within the water column to enhance their sunlight exposure. These cyanobacteria utilize photosynthesis to generate food so an absence of photosynthetic behavior would reduce their ability to survive.

In other embodiments, the ultrasonic excitation can also disrupt the cyanobacteria by disrupting the microbubbles on the surface of the cyanobacteria, which can cause the cell membrane of the cyanobacteria to be disrupted, thereby damaging, or destroying, the cyanobacterium itself

Cyanobacteria left alone may be able to remain low within the chamber which would limit their exposure to the UVC.

The experimental data illustrates a mitigation threshold value of 36 watt-seconds of UVC energy can reduce chlorophyll activity of cyanobacteria by as much as −56% during a 24-hour period. A reduction of chlorophyll equates to a reduction in photosynthetic behavior of the cyanobacteria.

The experimental data illustrates that UVC power of approximately 48 watt-seconds in combination with microbubbles and sonification utilizing ultrasonic transducers in quite effective in mitigating cyanobacteria. A frequency of 28 Khz @ 0.75 watts was delivered via two ultrasonic transducers. This treatment produced a significant reduction in chlorophyll, measuring an approximate reduction of −96.5% after a 24-hour observation period.

In another example, the reduction of chlorophyll levels were examined for a duplicate experiment, however this time we examined the chlorophyll levels after a 72-hour observation period. The chlorophyll levels after 72 hours measured at −59% of their original baseline or pretreatment levels. This suggests that even after a three-day window the activity of the cyanobacteria is significantly lower than pretreatment levels.

The inventors performed all of the experiments to test for mitigation of cyanobacteria as described herein. In order to measure the results of the mitigation experiments, spectroscopic observation experiments (and the data described herein) were performed at SUNY ESF in Syracuse, N.Y. and were supervised by their laboratory staff.

The benchtop tests were utilized to provide an approximation of the mitigation levels that could be obtained in a operational device. One embodiment of an operational device comprises 32 UVC lamps, configured in 2 rows of 16. Each lamp is a Rexim 6-watt hot filament lamp operating at 254 nm and when combined within the chamber it produced an accumulative value of 192 watts of UVC light.

The operational device is designed to traverse water at 1 mph, which given the size of the current chamber would produce a pass-through exposure time of 2.5 seconds. The approximate UVC energy the cyanobacteria will likely encounter would then approximate to be 192 watts×2.5 seconds=480 watt-seconds of exposure.

### Definitions

Any reference in the claims to an electronic signal or an electromagnetic signal (or their equivalents) is to be understood that in a preferred embodiment the signal is a non-transitory electronic signal or a non-transitory electromagnetic signal. If the signal per se is not claimed, the reference may in some instances be to a description of a propagating or transitory electronic signal or electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

### INCORPORATION BY REFERENCE

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An apparatus configured to collect and mitigate a harmful water-borne bacteria, comprising:
a water-going apparatus having a propulsion system, said water-going apparatus configured to collect water containing said harmful water-borne bacteria as a consequence of motion of said water-going apparatus relative to a body of water;
said water-going apparatus having a mechanical mechanism configured to collect and to localize water containing said harmful water-borne bacteria;
said water-going apparatus having at least one of an irradiation source, a source of microbubbles, and an ultrasonic transducer configured to apply, respectively, an illumination, a microbubble and ultrasonic sound to said localized water containing said harmful water-borne bacteria; and
said water-going apparatus having a controller configured to communicate with said at least one of said irradiation source, said source of microbubbles, and said ultrasonic transducer to control the respective operation of each.

2. The apparatus of claim 1, wherein the harmful water-borne bacteria is cyanobacteria.

3. The apparatus of claim 2, wherein said cyanobacterium is blue green algae.

4. The apparatus of claim 1, wherein the irradiation source comprises a UV-A, UV-B or UV-C irradiation source.

5. The apparatus of claim 1, wherein said irradiation source is configured to irradiate said harmful water-borne bacteria with electromagnetic radiation so as to render said harmful water-borne bacteria harmless.

6. The apparatus of claim 1, wherein said irradiation source is configured to irradiate said cyanobacterium so as to kill said harmful water-borne bacteria.

7. The apparatus of claim 1, wherein said irradiation source is configured to irradiate said harmful water-borne bacteria so as to cause adverse effects in genome integrity of said harmful water-borne bacteria.

8. The apparatus of claim 1, wherein said irradiation source is configured to produce UV-induced mutations in said harmful water-borne bacteria.

9. The apparatus of claim 1, wherein said mechanical mechanism comprises at least one of a paddle, a fixed filter, or electromechanical pump.

10. An apparatus configured to mitigate a harmful cyanobacterium, comprising:
a mechanical mechanism configured to collect and to localize water containing said harmful cyanobacterium;
at least one of an irradiation source, a source of microbubbles, and an ultrasonic transducer configured to apply, respectively, an illumination, a microbubble and ultrasonic sound to said localized water containing said harmful cyanobacterium; and
a controller configured to communicate with said at least one of said irradiation source, said source of microbubbles, and said ultrasonic transducer to control the respective operation of each.

11. A method of collecting and mitigating a harmful water-borne bacteria, comprising the steps of:
providing an apparatus comprising:
a water-going apparatus having a propulsion system, said water-going apparatus configured to collect water containing said harmful water-borne bacteria as a consequence of motion of said water-going apparatus relative to a body of water;
said water-going apparatus having a mechanical mechanism configured to collect and to localize water containing said harmful water-borne bacteria;
said water-going apparatus having at least one of an irradiation source, a source of microbubbles, and an ultrasonic transducer configured to apply, respectively, an illumination, a microbubble and ultrasonic sound to said localized water containing said harmful water-borne bacteria; and
said water-going apparatus having a controller configured to communicate with said at least one of said irradiation source, said source of microbubbles, and said ultrasonic transducer to control the respective operation of each;
operating said water-going apparatus to collect a harmful water-borne bacteria in a specimen of water;
using said controller to operate at least one of said at least one of an irradiation source, a source of microbubbles, and an ultrasonic transducer to apply, respectively, an illumination, a microbubble and ultrasonic sound to said localized water containing said harmful water-borne bacteria; and
thereby mitigating said harmful water-borne bacteria.

12. The method of claim 11, wherein said irradiation source comprises a UV-A, UV-B or UV-C irradiation source.

13. The method of claim 11, wherein the harmful water-borne bacteria is a cyanobacteria.

14. The method of claim 13, wherein said cyanobacterium is blue green algae.
